(19) United States
(12) Patent Application Publication
(10) Pub. No.: US 2025/0224486 A1
(43) Pub. Date: Jul. 10, 2025

(54) METHOD AND APPARATUS FOR MONITORING A VEHICLE BLIND ZONE

(71) Applicant: GM GLOBAL TECHNOLOGY OPERATIONS LLC, Detroit, MI (US)

(72) Inventors: Suhyun Lee, Seoul (KR); Hojung Lee, Seoul (KR)

(73) Assignee: GM GLOBAL TECHNOLOGY OPERATIONS LLC, Detroit, MI (US)

(21) Appl. No.: 18/406,469

(22) Filed: Jan. 8, 2024

(51) Int. Cl. G01S 7/04; B60Q 9/00; B60R 1/12; G01S 13/931

(52) U.S. Cl. CPC G01S 7/04; B60Q 9/008; B60R 1/12; G01S 13/931; B60R 2001/1215; G01S 2013/9323

(57) ABSTRACT

A vehicle system for monitoring a blind zone includes a monitoring system arranged to monitor an area rearward of the vehicle; an interior rearview mirror having a first controllable icon disposed on a rightward side thereof and a second controllable icon disposed on a leftward side thereof. The monitoring system is able to detect an object that is rearward to and proximal to the vehicle. The monitoring system is operative to determine that the object that is rearward to and proximal to the vehicle is disposed on a rightward side of the vehicle or a leftward side of the vehicle, illuminate the first controllable icon when the object that is rearward to and proximal to the vehicle is disposed on the rightward side; and illuminate the second controllable icon when the object that is rearward to and proximal to the vehicle is disposed on the leftward side.

Vehicle operation on highways includes steering maneuvers that result in lateral movement of the vehicle, such as for lane changing, merging onto a highway, exiting from a highway, object avoidance, etc. Some vehicles, and some operations of vehicles may result in occurrence of a blind zone, wherein a driver is unable to see, i.e., is unable to visually perceive presence of an object (e.g., another vehicle) in the vehicle's travel path as a steering maneuver is executed.

### SUMMARY

The concepts described herein include a vehicle system for monitoring a blind zone that includes a monitoring system arranged to monitor an area rearward of the vehicle; an interior rearview mirror having a first controllable icon disposed on a rightward side thereof and a second controllable icon disposed on a leftward side thereof; and a controller. The controller is in communication with the monitoring system and operatively connected to the first controllable icon and the second controllable icon, and the monitoring system is operative to detect an object that is rearward to and proximal to the vehicle. The monitoring system is operative to determine that the object that is rearward to and proximal to the vehicle is disposed on a rightward side of the vehicle or a leftward side of the vehicle, illuminate the first controllable icon when the monitoring system determines that the object that is rearward to and proximal to the vehicle is disposed on the rightward side of the vehicle; and illuminate the second controllable icon when the monitoring system determines that the object that is rearward to and proximal to the vehicle is disposed on the leftward side of the vehicle.

Another aspect of the disclosure may include the monitoring system being a radar system.

Another aspect of the disclosure may include the monitoring system being a LiDAR system.

Another aspect of the disclosure may include the monitoring system being operative to detect that the object is disposed in a blind zone proximal to the vehicle.

Another aspect of the disclosure may include the interior rearview mirror being a mirror lens being disposed on a mounting frame; wherein the first controllable icon is disposed on a rightward side of the mirror lens; and wherein the second controllable icon is disposed on a leftward side of the mirror lens.

Another aspect of the disclosure may include the interior rearview mirror being composed as mirror lens disposed on a mounting frame; wherein the first controllable icon is disposed on a rightward side of the mounting frame; and the second controllable icon is disposed on a leftward side of the mounting frame.

Another aspect of the disclosure may include the first controllable icon and the second controllable icon are devices affixed onto a surface of the interior rearview mirror.

Another aspect of the disclosure may include the devices affixed onto the surface of the interior rearview mirror being liquid-crystal display devices.

Another aspect of the disclosure may include the first controllable icon disposed on the rightward side of the interior rearview mirror and the second controllable icon disposed on the leftward side of the interior rearview mirror being devices embedded in the interior rearview mirror.

Another aspect of the disclosure may include the devices embedded in the interior rearview mirror being light-emitting diode devices.

Another aspect of the disclosure may include a driver's seat having a leftward haptic device and a rightward haptic device affixed thereto, wherein the controller controls the rightward haptic device when the monitoring system determines that the object that is rearward to and proximal to the vehicle is disposed on the rightward side of the vehicle; and wherein the controller controls the leftward haptic device when the monitoring system determines that the object that is rearward to and proximal to the vehicle is disposed on the leftward side of the vehicle.

Another aspect of the disclosure may include an audio system having a leftward speaker and a rightward speaker affixed thereto, wherein the controller controls the rightward speaker to issue a chime when the monitoring system determines that the object that is rearward to and proximal to the vehicle is disposed on the rightward side of the vehicle; and wherein the controller controls the leftward speaker to issue a chime when the monitoring system determines that the object that is rearward to and proximal to the vehicle is disposed on the leftward side of the vehicle.

Another aspect of the disclosure may include a vehicle system having a monitoring system arranged to monitor a blind zone of the vehicle; an interior rearview mirror having a first controllable icon disposed on a rightward side thereof and a second controllable icon disposed on a leftward side thereof; and a controller. The controller is in communication with the monitoring system and operatively connected to the first controllable icon and the second controllable icon. The monitoring system is operative to detect an object that is disposed in the blind zone; and to determine that the object disposed in the blind zone is disposed on one of a rightward side of the vehicle or a leftward side of the vehicle; The controller illuminates the first controllable icon when the monitoring system determines that the object that is disposed in the blind zone is on the rightward side of the vehicle. The controller illuminates the second controllable icon when the monitoring system determines that the object that is disposed in the blind zone is on the leftward side of the vehicle.

Another aspect of the disclosure may include a method for monitoring a blind zone of a vehicle that includes monitoring, via a monitoring system, an area rearward of the vehicle; detecting an object in the blind zone of the vehicle; determining that the object that is in the blind zone of the vehicle is disposed on a rightward side of the vehicle or a leftward side of the vehicle; illuminating a first controllable icon arranged in center-mounted interior rear view mirror when the monitoring system determines that the object that is in the blind zone of the vehicle is disposed on the rightward side of the vehicle; and illuminating a second controllable icon when the monitoring system determines that the object that is in the blind zone of the vehicle is disposed on the leftward side of the vehicle.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 pictorially illustrates a side view of a vehicle that is disposed on a road surface, in accordance with the disclosure.

FIG. 2 schematically illustrates an isometric view of a forward portion of cabin area of a vehicle, in accordance with the disclosure.

FIG. 3 schematically illustrates a top view of a vehicle that is disposed on a road surface, in accordance with the disclosure.

FIG. 4 schematically illustrates a control scheme for controlling aspects of a vehicle, in accordance with the disclosure.

The appended drawings are not necessarily to scale, and may present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but merely represents possible embodiments thereof. In addition, while numerous specific details are set forth in the following description to provide a thorough understanding of the embodiments disclosed herein, some embodiments may be practiced without some of these details. Moreover, for the purpose of clarity, certain technical material that is understood in the related art has not been described in detail in order to avoid unnecessarily obscuring the disclosure.

Furthermore, the disclosure, as illustrated and described herein, may be practiced in the absence of an element that is not specifically disclosed herein.

The following detailed description is merely exemplary in nature and is not intended to limit the application and uses. Furthermore, there is no intention to be bound by any expressed or implied theory presented herein. Throughout the drawings, corresponding reference numerals indicate like or corresponding parts and features.

For purposes of convenience and clarity only, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

As employed herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

The use of ordinals such as first, second and third does not necessarily imply a ranked sense of order, but may only distinguish between multiple instances of an act or structure.

The disclosure, as illustrated and described herein, may be practiced in the absence of an element that is not specifically disclosed herein.

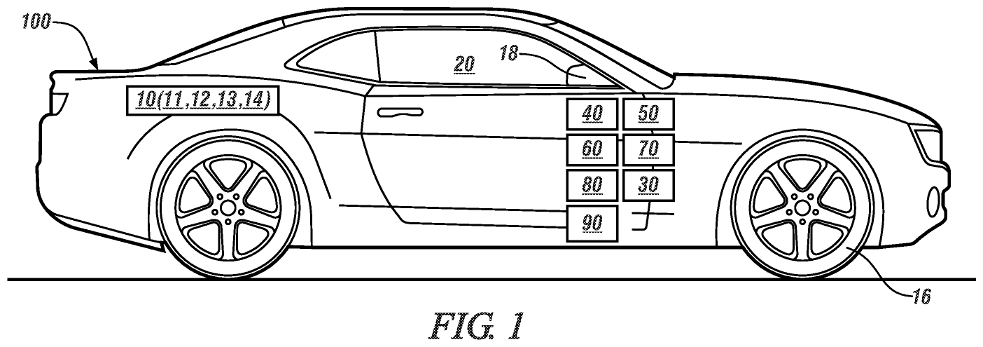

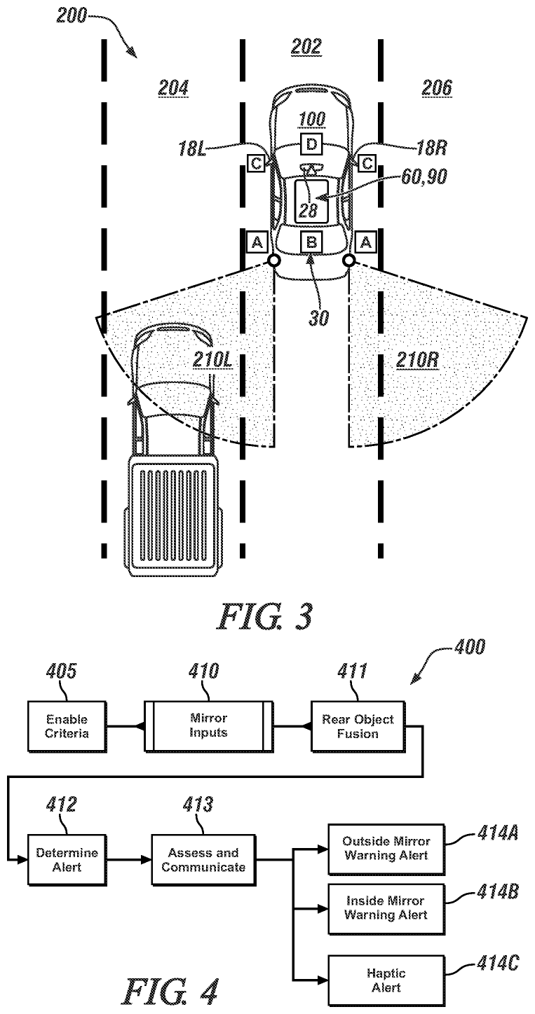

Referring to the drawings, wherein like reference numerals correspond to like or similar components throughout the several Figures, FIG. 1, consistent with embodiments disclosed herein, illustrates elements of a vehicle 100 that is equipped with a blind zone monitoring system 90 that performs blind zone monitoring and visually, audibly, and/or haptically informs a driver of presence (or absence) of an object within a vehicle blind zone. Details related to the blind zone monitoring system 90 are described with reference to FIGS. 3, et seq. The vehicle 100 may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure.

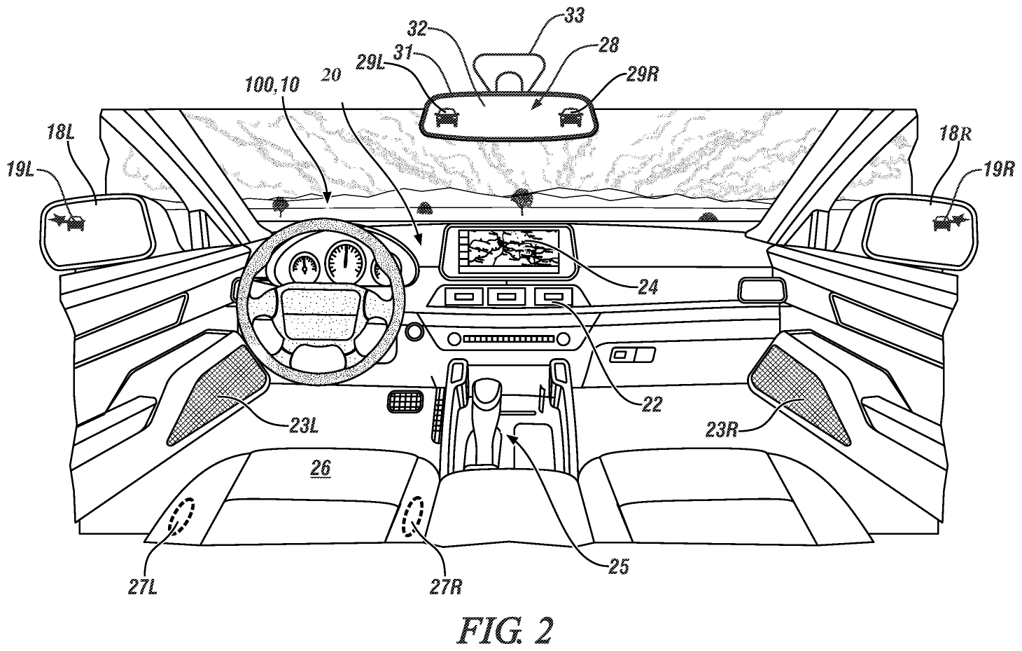

Referring again to FIGS. 1 and 2, the vehicle 100 is disposed on and able to traverse a travel surface such as a paved road surface. The vehicle 100 may include a vehicle operating system 10, passenger cabin 20, spatial monitoring system 30, advanced driver assistance system (ADAS) 40, navigation system 50, human/machine interface (HMI) 60, telematics system 70, sideview mirror(s) 18, and vehicle monitoring system 80. Some of these elements may be absent from some embodiments.

The vehicle operating system 10 is composed of a propulsion system 11, a braking system 12, a suspension system 13, and a steering system 14, all of which are attached, connected, coupled or otherwise interact with one or more wheels 16, a portion which are steerable. Operations of the various elements of the vehicle operating system 10 are controlled by one or multiple controllers in response to operator inputs to operator controls 25 that are within the passenger cabin 20.

The spatial monitoring system 30 includes, in one embodiment, one or a plurality of spatial sensors and systems that are arranged to monitor a viewable region that is peripheral to the vehicle 100, including forward, rearward, leftward, and rightward of the vehicle 100, and a spatial monitoring controller. The spatial sensors may include, e.g., a video camera, a LiDAR sensor, a radar sensor, an ultrasound sensor, and/or another device, and are disposed on-vehicle to monitor at least a portion of the viewable region to detect proximate remote objects such as road features, lane markers, buildings, pedestrians, road signs, traffic control lights and signs, other vehicles, and geographic features that are proximal to the vehicle 100. Elements of the spatial monitoring system 30 are in communication with and employed by the blind zone monitoring system 90.

The ADAS 40 is configured to implement autonomous driving or ADAS vehicle functionalities, employing inputs from the navigation system 50 and the spatial monitoring system 30. Such functionality may include an on-vehicle control system that is capable of providing a level of driving automation. The terms ‘driver’ and ‘operator’ describe the person responsible for directing operation of the vehicle 100, whether actively involved in controlling one or more vehicle functions or directing autonomous vehicle operation. Driving automation may include a range of dynamic driving and vehicle operation. Driving automation may include some level of automatic control or intervention related to a single vehicle function, such as steering, acceleration, and/or braking, with the driver continuously having overall control of the vehicle 100. Driving automation may include some level of automatic control or intervention related to simultaneous control of multiple vehicle functions, such as steering, acceleration, and/or braking, with the driver continuously having overall control of the vehicle 100. Driving automation may include simultaneous automatic control of vehicle driving functions that include steering, acceleration, and braking (via steering system 14, propulsion system 11, and braking system 12, respectively) wherein the driver cedes control of one or more of the vehicle driving functions of the vehicle 100 for a period of time during a trip. Autonomous vehicle functions may include, by way of non-limiting examples, an adaptive cruise control (ACC) operation, lane guidance and lane keeping operation, lane change operation, steering assist operation, object avoidance operation, parking assistance operation, vehicle braking operation, collision avoidance operation, vehicle speed and acceleration operation, vehicle lateral motion operation, e.g., as part of the lane guidance, lane keeping and lane change operations, etc.

The navigation system 50 may include on-board and/or off-board maps and a global positioning system (GPS) sensor, and provides a vehicle operator with location information and point-to-point travel route execution.

The HMI 60 includes touchscreen(s), audio devices, and controller(s) that facilitates communication, interaction, and control of the ADAS 40, the spatial monitoring system 30, the navigation system 50, and the telematics system 70. The HMI 60 enables a vehicle operator to interact with and direct operation of the vehicle 100 in functioning to provide passenger communication, navigation, infotainment, environmental comfort, etc., and to gain access to recessed areas on-vehicle. Operator interface devices may include devices that are capable of transmitting a message.

The telematics system 70 includes a wireless telematics communication system capable of extra-vehicle communication, including communicating with a communication network (not shown) having wireless and wired communication capabilities. The extra-vehicle communications may include short-range vehicle-to-vehicle (V2V) communication and/or vehicle-to-everything (V2x) communication, which may include communication with an infrastructure monitor, e.g., a traffic camera. Alternatively, or in addition, the telematics system 70 may include wireless telematics communication systems that are capable of short-range wireless communication to a handheld device, e.g., a cell phone, a satellite phone or another telephonic device. In one embodiment the handheld device includes a software application that includes a wireless protocol to communicate with the telematics system 70, and the handheld device executes the extra-vehicle communication, including communicating with an off-board server via the wireless communication network. Alternatively, or in addition, the telematics system 70 may execute the extra-vehicle communication directly by communicating with a remote facility via the communication network.

The vehicle monitoring system 80 includes a plurality of sensors and calibrated routines that are arranged to monitor a plurality of operating parameters of the vehicle operating system 10, including, e.g., vehicle speed, acceleration, braking, yaw rate, roll, pitch, etc.

The vehicle 100 includes a center-mounted interior rearview mirror 28, which includes a mirror lens 32 disposed on a mounting frame 31 that is attached to a windshield 33 of the vehicle 100 in one embodiment. The interior rearview mirror 28 includes a leftward controllable icon 29L and a rightward controllable icon 29R, wherein the leftward internal controllable icon 29L and the rightward internal controllable icon 29R that are disposed on the mirror lens 32 and are in communication with the HMI 60. Alternatively, the leftward internal controllable icon 29L and the rightward internal controllable icon 29R are disposed on the mounting frame 31 and are in communication with the HMI 60. The leftward internal controllable icon 29L and the rightward internal controllable icon 29R are devices that are embedded in the interior rearview mirror 28, and are light-emitting diode devices in one embodiment. The leftward internal controllable icon 29L and the rightward internal controllable icon 29R are devices that are affixed onto a surface of the interior rearview mirror 28. In one embodiment, the leftward internal controllable icon 29L and the rightward internal controllable icon 29R are liquid crystal display (LCD) devices.

The HMI 60 includes software algorithms and activation elements that are configured to selectively activate the leftward internal controllable icon 29L and the rightward internal controllable icon 29R, such as in response to detection of an object in a vehicle blind zone.

The vehicle 100 includes externally mounted left and right sideview mirrors 18L, 18R, respectively, having a leftward external controllable icon 19L and a rightward external controllable icon 19R, respectively. The leftward external controllable icon 19L and the rightward external controllable icon 19R are in communication with the HMI 60. The HMI 60 includes software algorithms and activation elements that are configured to selectively activate the leftward external controllable icon 19L and the rightward external controllable icon 19R, such as in response to detection of an object in a vehicle blind zone.

The operator controls 25 may include, by way of non-limiting examples, an accelerator pedal, a brake pedal, a turn signal indicator, a suspension selection switch, a transmission range selector (PRNDL), a cruise control actuator, an ADAS actuator, a parking brake, and/or other operator-controlled devices. One or multiple HVAC vents 22 may also be included.

The driver's seat 26 may be advantageously equipped with leftward and rightward haptic devices 27L, 27R, respectively, that are controllable by the HMI 60. The leftward and rightward haptic devices 27L, 27R may be disposed in a driver seat bottom, a seat back, and/or another location.

The communication devices may include an audio system with at least one speaker, including, in one embodiment, leftward and rightward speakers 23L, 23R, respectively, that are controllable by the HMI 60. The leftward and rightward speakers 23L, 23R are controllable to emit an audible chime in response to an activation signal from the HMI 60.

The visual display system 24 may be arranged as an electronic visual display device, e.g., a touchscreen that is capable of electronic presentation of still images, text, and/or video in black-and-white and/or color formats. The visual display system 24 includes one or more of a driver information center display screen, a heads-up display, vehicle interior lighting, left and right sideview mirrors, a rear-view mirror, etc. In one embodiment, the visual display system 24 is an electronic visual display module, e.g., a liquid crystal display (LCD) device having touch-screen capability.

The HMI 60 facilitates communication and interaction with the ADAS 40, the spatial monitoring system 30, the navigation system 50, and the telematics system 70.

The HMI 60 enables a vehicle operator to interact with and direct operation of the vehicle 100 in functioning to provide passenger communication, navigation, infotainment, environmental comfort, etc., and to gain access to recessed areas on-vehicle. Operator interface devices may include devices that are capable of transmitting a message.

FIG. 3 schematically illustrates a top view of the vehicle 100 that is described with reference to FIGS. 1 and 2, which is disposed on travel lane 202 of roadway 200. Also depicted are vehicle blind zones, including a leftward blind zone coverage area 210L and a rightward blind zone coverage area 210R. The leftward blind zone coverage area 210L includes an area in the travel lane 202, and an area leftward of the vehicle 100, which may be an adjacent travel lane 204 (as shown), or a berm area, another travel area, a barrier, etc. The rightward blind zone coverage area 210R includes an area in the travel lane 202, and an area rightward of the vehicle 100, which may be an adjacent travel lane, or a berm area 206 (as shown), another travel area, a barrier, etc. The vehicle 100 includes externally mounted left and right sideview mirrors 18L, 18R, respectively, the center-mounted interior rearview mirror 28, the spatial monitoring system 30, the HMI 60, and the blind zone monitoring system 90. The leftward blind zone coverage area 210L and the rightward blind zone coverage area 210R include, in one embodiment, areas that are within 3 m orthogonal to a longitudinal axis of the vehicle 100, and within 25 m of a rear fascia of the vehicle and parallel to the longitudinal axis of the vehicle 100. These dimensions of the leftward blind zone coverage area 210L and the rightward blind zone coverage area 210R are illustrative of one embodiment. It is appreciated that dimensions of the leftward blind zone coverage area 210L and the rightward blind zone coverage area 210R may be vehicle-dependent. As such, the dimensions may vary depending upon whether the vehicle 100 is a passenger vehicle, a light-duty truck, a heavy duty tractor trailer, an agricultural machine, etc. Furthermore, the dimensions may vary depending upon whether the vehicle 100 is a passenger vehicle or a light-duty truck that is pulling a trailer. It is appreciated that dimensions of the leftward blind zone coverage area 210L and the rightward blind zone coverage area 210R may be situation-dependent. As such, the dimensions may vary depending upon a travel speed of the vehicle 100, a type of roadway, roadway conditions (traffic, travel surface conditions due to weather, etc.), etc. In one embodiment, the blind zone monitoring system 90 is able to select and/or adjust the dimensions of the leftward blind zone coverage area 210L and/or the rightward blind zone coverage area 210R based upon elements related to the vehicle 100 and situational elements such as traffic, vehicle speed, roadway conditions, and weather conditions, so as to inform a driver of a risk of a collision.

FIG. 4 schematically illustrates an embodiment a blind zone monitoring control routine 400 associated with the blind zone monitoring system 90 of vehicle 100.

The blind zone monitoring control routine 400 operates when enable criteria are met (Step 405). Enable criteria may include the transmission range selector (PRNDL) of the operator controls 25 of the vehicle 100 being in a Drive or Reverse position in one embodiment. Enable criteria may include the vehicle 100 operating at a speed that is greater than a minimum speed.

The blind zone monitoring control routine 400 regularly, periodically, and/or ongoingly monitors inputs from the spatial monitoring system 30 (Step 410) and executes one or more fusion algorithms (Step 411) to detect presence of an object within either or both the leftward blind zone coverage area 210L or the rightward blind zone coverage area 210R (illustrated with reference to FIG. 3).

When presence of one or multiple object(s) is detected in either or both the leftward blind zone coverage area 210L or the rightward blind zone coverage area 210R, an alert is generated (Step 412), and is communicated to the HMI 60 (Step 413). The HMI 60 assesses the detected object(s).

The HMI 60 communicates an alert in the form of icon activation signal(s) to illuminate or otherwise activate one or both the leftward internal controllable icon 29L and the rightward internal controllable icon 29R, depending upon whether the object(s) is detected in either or both the leftward blind zone coverage area 210L or the rightward blind zone coverage area 210R, respectively (Step 414A). The icon activation signal(s) may result in constant illumination of the respective icon, or a blinking illumination of the respective icon, or a constant illumination of the respective icon with controllably variable intensity, or another illumination scheme.

The HMI 60 communicates an alert in the form of icon activation signal(s) to illuminate or otherwise activate one or both the leftward external controllable icon 19L and the rightward external controllable icon 19R, depending upon whether the object(s) is detected in either or both the leftward blind zone coverage area 210L or the rightward blind zone coverage area 210R, respectively (Step 414B). The icon activation signal(s) may result in constant illumination of the respective icon, or a blinking illumination of the respective icon, or a constant illumination of the respective icon with controllably variable intensity, or another illumination scheme.

The HMI 60 communicates an alert in the form of haptic activation signals to one or both the leftward haptic device 27L and rightward haptic device 27R, depending upon whether the object(s) is detected in either or both the leftward blind zone coverage area 210L or the rightward blind zone coverage area 210R, respectively (Step 414C). The haptic activation signal(s) may result in constant activation of the respective haptic device, or a periodic activation of the respective haptic device, or a constant activation of the respective haptic device with controllably variable intensity, or another activation scheme.

The HMI 60 communicates an alert in the form of activation signals to one or both the leftward speaker 23L and the rightward speaker 23R, depending upon whether the object(s) is detected in either or both the leftward blind zone coverage area 210L or the rightward blind zone coverage area 210R, respectively (Step 414C). The leftward and rightward speakers 23L, 23R are controllable to emit an audible chime in response to an activation signal from the HMI 60. The audible chime is location-specific, so as to inform the driver of the presence of an object in the leftward or rightward blind zones of the vehicle 100. The speaker activation signal(s) may result in constant audible sound of the respective speaker, or a periodic audible sound of the respective speaker, or a constant audible sound of the respective icon with controllably variable loudness, or another sound.

The term “controller” and related terms such as microcontroller, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component stores machine readable instructions in the form of one or more software or firmware programs or routines, combinational logic circuit(s), input/output circuit(s) and devices, signal conditioning and buffer circuitry and other components that may be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event.

Communication between controllers, actuators and/or sensors may be accomplished using a direct wired point-to-point link, a networked communication bus link, a wireless link or another suitable communication link, including, e.g., an Ethernet link and a controller area network (CAN) link. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers.

The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, which is capable of traveling through a medium. A parameter is defined as a measurable quantity that represents a physical property of a device or other element that is discernible using one or more sensors and/or a physical model. A parameter may have a discrete value, e.g., either “1” or “0”, or may be infinitely variable in value.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by dedicated-function hardware-based systems that perform the specified functions or acts, or combinations of dedicated-function hardware and computer instructions. These computer program instructions may also be stored in a computer-readable medium that may direct a computer or other programmable data processing apparatus to function in a particular manner, such that the instructions stored in the computer-readable medium produce an article of manufacture including instruction set that implements the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A vehicle system for monitoring a blind zone, the system comprising:
a monitoring system arranged to monitor an area rearward of the vehicle;
an interior rearview mirror having a first controllable icon disposed on a rightward side thereof and a second controllable icon disposed on a leftward side thereof; and
a controller;
wherein the controller is in communication with the monitoring system and operatively connected to the first controllable icon and the second controllable icon;
wherein the monitoring system is operative to detect an object that is rearward to and proximal to the vehicle;
wherein the monitoring system is operative to determine that the object that is rearward to and proximal to the vehicle is disposed on a rightward side of the vehicle or a leftward side of the vehicle;
wherein the controller illuminates the first controllable icon when the monitoring system determines that the object that is rearward to and proximal to the vehicle is disposed on the rightward side of the vehicle; and
wherein the controller illuminates the second controllable icon when the monitoring system determines that the object that is rearward to and proximal to the vehicle is disposed on the leftward side of the vehicle.

2. The vehicle system of claim 1, wherein the monitoring system comprises a radar system.

3. The vehicle system of claim 1, wherein the monitoring system comprises a LiDAR system.

4. The vehicle system of claim 1, wherein the monitoring system being operative to determine that the object that is rearward to and proximal to the vehicle is disposed on the rightward side of the vehicle or the leftward side of the vehicle comprises the monitoring system being operative to detect that the object is disposed in a blind zone proximal to the vehicle.

5. The vehicle system of claim 1, wherein the interior rearview mirror is a mirror lens disposed on a mounting frame;
wherein the first controllable icon being disposed on the rightward side of the interior rearview mirror comprises the first controllable icon being disposed on a rightward side of the mirror lens; and
wherein the second controllable icon being disposed on the leftward side of the interior rearview mirror comprises the second controllable icon being disposed on a leftward side of the mirror lens.

6. The vehicle system of claim 1, wherein the interior rearview mirror is composed as mirror lens disposed on a mounting frame;
wherein the first controllable icon being disposed on the rightward side of the interior rearview mirror comprises the first controllable icon being disposed on a rightward side of the mounting frame; and
wherein the second controllable icon being disposed on the leftward side of the interior rearview mirror comprises the second controllable icon being disposed on a leftward side of the mounting frame.

7. The vehicle system of claim 1, wherein the first controllable icon disposed on the rightward side of the interior rearview mirror and the second controllable icon disposed on the leftward side of the interior rearview mirror comprise devices affixed onto a surface of the interior rearview mirror.

8. The vehicle system of claim 7, wherein the devices affixed onto the surface of the interior rearview mirror comprise liquid-crystal display devices.

9. The vehicle system of claim 1, wherein the first controllable icon disposed on the rightward side of the interior rearview mirror and the second controllable icon disposed on the leftward side of the interior rearview mirror comprise devices embedded in the interior rearview mirror.

10. The vehicle system of claim 9, wherein the devices embedded in the interior rearview mirror comprise light-emitting diode devices.

11. The vehicle system of claim 1, further comprising a driver's seat having a leftward haptic device and a rightward haptic device affixed thereto, wherein the controller controls the rightward haptic device when the monitoring system determines that the object that is rearward to and proximal to the vehicle is disposed on the rightward side of the vehicle; and
wherein the controller controls the leftward haptic device when the monitoring system determines that the object that is rearward to and proximal to the vehicle is disposed on the leftward side of the vehicle.

12. The vehicle system of claim 11, further comprising an audio system having a leftward speaker and a rightward speaker affixed thereto, wherein the controller controls the rightward speaker to issue a chime when the monitoring system determines that the object that is rearward to and proximal to the vehicle is disposed on the rightward side of the vehicle; and
wherein the controller controls the leftward speaker to issue a chime when the monitoring system determines that the object that is rearward to and proximal to the vehicle is disposed on the leftward side of the vehicle.

13. A vehicle system, the system comprising:
a monitoring system arranged to monitor a blind zone of the vehicle;
an interior rearview mirror having a first controllable icon disposed on a rightward side thereof and a second controllable icon disposed on a leftward side thereof; and
a controller;
wherein the controller is in communication with the monitoring system and operatively connected to the first controllable icon and the second controllable icon;
wherein the monitoring system is operative to detect an object that is disposed in the blind zone;
wherein the monitoring system is operative to determine that the object disposed in the blind zone is disposed on a rightward side of the vehicle or a leftward side of the vehicle;
wherein the controller illuminates the first controllable icon when the monitoring system determines that the object that is disposed in the blind zone is on the rightward side of the vehicle; and
wherein the controller illuminates the second controllable icon when the monitoring system determines that the object that is disposed in the blind zone is on the leftward side of the vehicle.

14. The vehicle system of claim 13, wherein the monitoring system comprises one of a radar system or a LiDAR system.

15. The vehicle system of claim 13, wherein the interior rearview mirror is a mirror lens disposed on a mounting frame;
wherein the first controllable icon being disposed on the rightward side of the interior rearview mirror comprises the first controllable icon being disposed on a rightward side of the mirror lens; and
wherein the second controllable icon being disposed on the leftward side of the interior rearview mirror comprises the second controllable icon being disposed on a leftward side of the mirror lens.

16. The vehicle system of claim 13, wherein the interior rearview mirror is composed as mirror lens disposed on a mounting frame;
wherein the first controllable icon being disposed on the rightward side of the interior rearview mirror comprises the first controllable icon being disposed on a rightward side of the mounting frame; and
wherein the second controllable icon being disposed on the leftward side of the interior rearview mirror comprises the second controllable icon being disposed on a leftward side of the mounting frame.

17. The vehicle system of claim 13, wherein the first controllable icon disposed on the rightward side of the interior rearview mirror and the second controllable icon disposed on the leftward side of the interior rearview mirror comprise devices affixed onto a surface of the interior rearview mirror.

18. The vehicle system of claim 13, wherein the first controllable icon disposed on the rightward side of the interior rearview mirror and the second controllable icon disposed on the leftward side of the interior rearview mirror comprise devices embedded in the interior rearview mirror.

19. The vehicle system of claim 13, further comprising a driver's seat having a leftward haptic device and a rightward haptic device affixed thereto, wherein the controller controls the rightward haptic device when the monitoring system determines that the object that is disposed in the blind zone of the vehicle is disposed on the rightward side of the vehicle; and
wherein the controller controls the leftward haptic device when the monitoring system determines that the object that is disposed in the blind zone of the vehicle is disposed on the leftward side of the vehicle.

20. A method for monitoring a blind zone of a vehicle, the method comprising:
monitoring, via a monitoring system, an area rearward of the vehicle;
detecting an object in the blind zone of the vehicle;
determining that the object that is in the blind zone of the vehicle is disposed on a rightward side of the vehicle or a leftward side of the vehicle;
illuminating a first controllable icon arranged in center-mounted interior rear view mirror when the monitoring system determines that the object that is in the blind zone of the vehicle is disposed on the rightward side of the vehicle; and
illuminating a second controllable icon when the monitoring system determines that the object that is in the blind zone of the vehicle is disposed on the leftward side of the vehicle.
